(19) United States
(12) Patent Application Publication
(10) Pub. No.: US 2004/0104854 A1
(43) Pub. Date: Jun. 3, 2004

(54) Antenna assembly and method of assembling the same

(76) Inventors: Hsien-Chu Lin, Tu-Chen (TW); Chieh Chao Yu, Tu-Chen (TW); Yung-Chien Chung, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/327,169

(22) Filed: Dec. 20, 2002

(30) Foreign Application Priority Data
Nov. 29, 2002 (TW) 91134740

(51) Int. Cl. H01Q 1/24; H01Q 1/42

(52) U.S. Cl. 343/702; 343/872

(57) ABSTRACT

An antenna assembly (1) includes a host device (3) and an antenna unit (2). The host device includes a front cover (41) covering a front face thereof and an extension box (413) retained by the front cover. The antenna unit includes an antenna element (21) received in the extension box.

### BACKGROUND OF THE INVENTION

1. Field of the Invention

The present invention relates to an antenna assembly, and in particular to an antenna assembly which combines an antenna element with an electrical device.

2. Description of the Prior Art

With current developments in communication technology, such as Wireless Local Area Network (WLAN), Bluetooth and HomeRF, many desktop computers now have the function of wireless telecommunication at close range. To achieve this function, an antenna is used with a desktop computer for receiving and transmitting signals. One conventional antenna for a WLAN card with a Peripheral Component Interconnect (PCI) interface is for external mounting. The WLAN card is mounted to a PCI expansion slot in a desktop computer with a bracket covering a corresponding slot in a back cover of an enclosure of the desktop computer. The antenna is mounted to an exterior side of the bracket and electrically connects with the WLAN card through the bracket. However, the antenna is exposed to an outside of the enclosure and can be easily damaged, so the performance of the antenna is not really reliable. A second conventional antenna is directly mounted in the enclosure of the desktop computer by soldering or screwing to an inner surface thereof. However, this antenna is inconvenient to assemble or disassemble. Furthermore, another disadvantage of this antenna is that the screwing process defaces the appearance of the enclosure.

Hence, an improved antenna assembly is desired to overcome the above-mentioned shortcomings of existing antennas.

### BRIEF SUMMARY OF THE INVENTION

A main object of the present invention is to provide an antenna assembly which is capable of protecting an antenna element from damage by the environment without defacing the appearance of a host device to which the antenna element is mounted.

An antenna assembly in accordance with the present invention comprises an antenna unit and an electrical device in which the antenna is mounted. The electrical device includes a front cover covering a front face thereof and an extension box retained in the front cover. The antenna unit comprises an antenna element, an electrical connector, and a feeder cable interconnecting the antenna element and the electrical connector. The antenna element is received in the extension box. The feeder cable extends through the extension box and the electrical connector is electrically connected with a compartment connector of the electrical device.

Because the antenna element is mounted in the extension box, the antenna assembly is capable of protecting the antenna element from damage by the environment without defacing the appearance of the host device.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of an antenna assembly in accordance with the present invention;

FIG. 2 is a perspective view of an extension box and an antenna unit of the antenna assembly of FIG. 1;

FIG. 3 is an exploded view of FIG. 2.

### DETAILED DESCRIPTION OF THE INVENTION

Reference will now be made in detail to a preferred embodiment of the present invention.

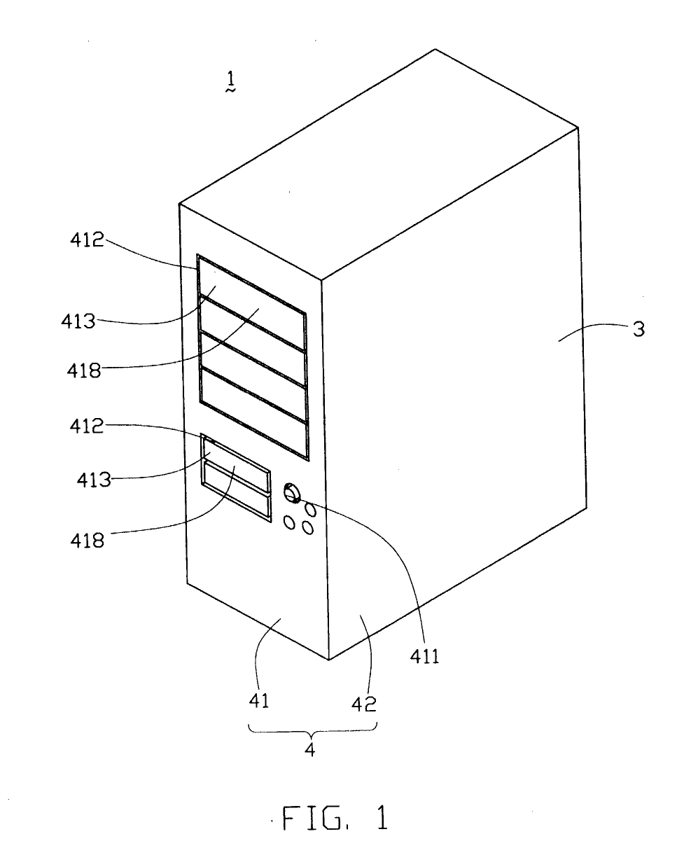

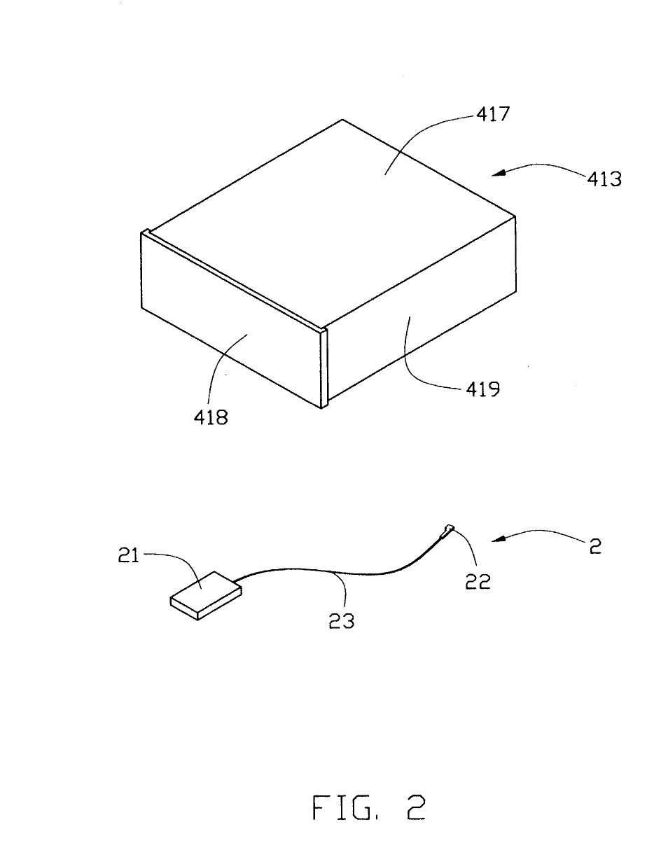

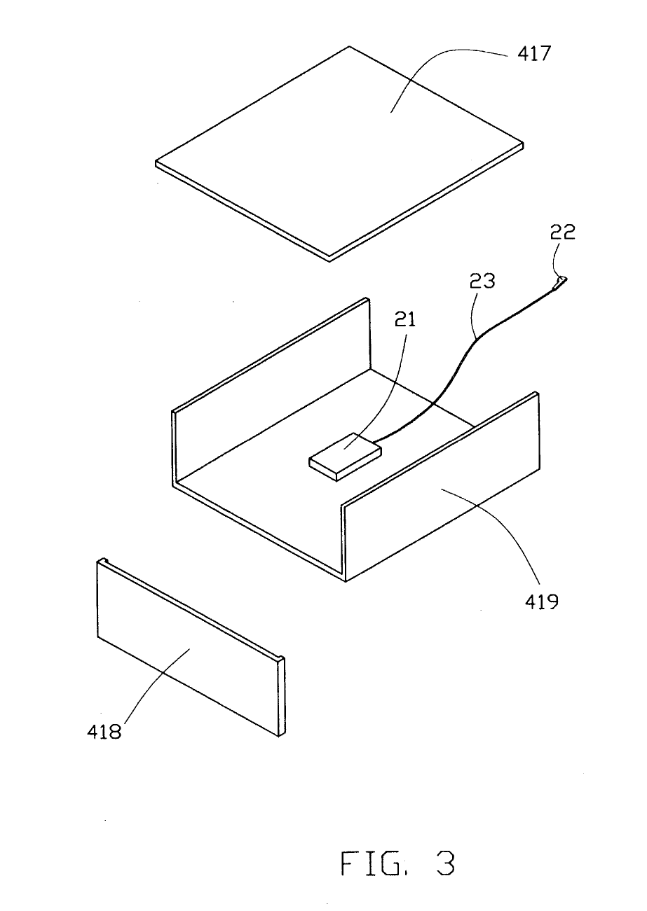

Referring to FIGS. 1, 2 and 3, an antenna assembly 1 in accordance with the present invention comprises an antenna unit 2 and a host device 3, here a desktop computer.

The antenna unit 2 comprises an antenna element 21, a radio frequency (RF) connector 22, and a coaxial feeder cable 23 interconnecting the antenna element 21 and the RF connector 22.

The host device 3 comprises a casing 4 and a plurality of components (not shown) accommodated in the casing 4. The casing 4 is substantially rectangular and includes a front cover 41 covering a front face thereof, and a removable side panel 42 covering a side thereof. A power switch button 411 is positioned on the front cover 41. The front cover 41 defines a plurality of extension apertures 412 having different sizes of 5.25 inches or 3.5 inches. The 5.25-inch or 3.5-inch extension apertures 412 can be provided for respectively receiving peripheral drives (such as 5.25-inch or 3.5-inch floppy disk drives, not shown). The host device 3 further comprises a 5.25-inch or 3.5-inch extension box 413 retained by a corresponding extension aperture 412. The extension box 413 comprises a top wall 417, a front wall 418 and a base portion 419. The front wall 418 is provided for engaging with the corresponding extension aperture 412.

In assembly, the antenna element 21 is mounted on an inner side of the front wall 418, the top wall 417 or the base portion 419 by a known process such as soldering or screwing, etc., thereby being mounted in the extension box 413. The front wall 418 is securely retained in the extension aperture 412, thereby securing the extension box 413 in the extension aperture 412. The coaxial feeder cable 23 extends through the extension box 413 and the RF connector 22 electrically connects with a compartment connector (not shown) of the host device 3. The side panel 42 is mounted on the side of the host device 3.

It is well known that a host device of a desktop computer or other host device usually defines some redundant extension apertures, and the antenna assembly 1 of the present invention utilizes one such extension aperture 412 to accommodate the antenna element 21. It is convenient to assemble or remove the antenna unit 2 to or from the antenna assembly 1 by replacing the extension box 413 in the extension aperture 412.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna assembly comprising:
an electrical device comprising a front cover covering a front face thereof and an extension box retained by the front cover; and
an antenna unit comprising an antenna element, an electrical connector, and a feeder cable interconnecting the antenna element and the electrical connector, the antenna element being received in the extension box, the feeder cable extending through the extension box and the electrical connector being electrically connected with a compartment connector of the electrical device.

2. The antenna assembly as claimed in claim 1, wherein the front cover defines an extension aperture engaging with the extension box.

3. The antenna assembly as claimed in claim 2, wherein the extension box comprises a front wall engaging with the extension aperture, the antenna element being mounted on the front wall.

4. The antenna assembly as claimed in claim 2, wherein the extension aperture can be provided for receiving a 3.5-inch peripheral device.

5. The antenna assembly as claimed in claim 2, wherein the extension aperture can be provided for receiving a 5.25-inch peripheral device.

6. The antenna assembly as claimed in claim 1, wherein the electrical device is a desktop computer.

7. A method of assembling an antenna in an electrical device, comprising:
providing an antenna unit comprising an antenna element;
providing an extension box;
mounting the antenna element in the extension box;
installing the extension box into the electrical device and engaging the extension box with a front cover of the electrical device.

8. The method as claimed in claim 7, wherein the front cover defines an extension aperture engaging with the extension box.

9. The method as claimed in claim 8, wherein the extension box comprises a front wall engaging with the extension aperture.

10. The method as claimed in claim 8, wherein the extension aperture can be provided for receiving a 3.5-inch peripheral device.

11. The method as claimed in claim 8, wherein the extension aperture can be provided for receiving a 5.25-inch peripheral device.

12. The method as claimed in claim 7, wherein the antenna unit further comprises an electrical connector, and a feeder cable interconnecting the antenna element and the electrical connector.

13. The method as claimed in claim 12, wherein the feeder cable extends through the extension box and the electrical connector is electrically connected with a compartment connector of the electrical device.

14. An computer system comprising:
a front cover defining at least one extension aperture therein for receiving at least one additional drive therein;
an extension box dimensioned in compliance with said at least one extension aperture and detachably attachably inserted to said at least one extension aperture and located inside the front cover; and
an antenna unit associated with said extension box and hidden behind the front cover, said antenna including a feeder cable with a connector at a distal end for connecting to a compartment connector of an electrical device located in the computer system.
